(19) United States
(12) Patent Application Publication
(10) Pub. No.: US 2006/0133535 A1
(43) Pub. Date: Jun. 22, 2006

(54) Apparatus and method for linearizing adaptive array antenna system

(76) Inventors: Jae-Ho Jung, Daejon (KR); Deuk-Su Lyu, Daejon (KR); Hyun-Seo Oh, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/531,634

(22) PCT Filed: Dec. 30, 2002
(86) PCT No.: PCT/KR02/02478

§ 371 Date: Nov. 17, 2005

(30) Foreign Application Priority Data
Oct. 16, 2002 (KR) 10-2002-0063282

(51) Int. Cl. H04L 25/03; H04L 27/04

(52) U.S. Cl. 375/296; 375/299

(57) ABSTRACT

Disclosed is an apparatus and method for linearizing an adaptive array antenna system. The apparatus and method for linearizing an adaptive array antenna system uses an identical feedback path as feedback path for estimation of a transfer function and a feedback path for linearization of each transmission channel in a multi-channel transmitter, thereby reducing hardware complexity of an adaptive array transmitter.

### TECHNICAL FIELD

The present invention relates to an adaptive array antenna system linearizing each transmitting channel of a multichannel transmitter by using identical feed-back path used for an error compensation method measuring a transfer function by feed-backing transmitting signal of each transmission channel at multi-channel transmitter and a method thereof.

### BACKGROUND ART

There is a limitation for improving a performance and capacity of mobile communication system due to wireless channel characteristics such as co-channel interference signal and path loss generated inner cell or between cells, multipath fading, signal delay and Doppler effect and shadow area. For overcoming the limitation, various compensation techniques have been introduced such as power control, channel coding, RAKE receiving, diversity antenna, cell secterization, distribution of frequency and spread spectrum. Recently, the number of users using the mobile communication service has been incredibly increased and the users also demand various kinds of mobile communication services. For satisfying user's demands, it requires high performance and mass capacity mobile communication service systems. Therefore, it is expected that conventional mobile communication technology could not provide the mobile communication service to satisfy the above mentioned user's demand in near future.

Recently, an International Mobile Telecommunications 2000 IMT-2000, which is a standard of next generation mobile communication system, has been introduced. Accordingly, competitions for development and standization of related techniques are getting intense between nations. In next generation of mobile communication system, high performance data and video service system has been required for transmitting various packets and video signal. Mobile communication system of 21 century would provide various multimedia communication services and must be capable of handling high quality and mass capacity data comparing to the conventional cellular and PCS mobile communication. Also, in a view of voice quality, the mobile communication system of 21 century must provide high quality voice service same or higher than a voice service quality of conventional telephone.

Furthermore, it would be essential condition to reduce influence of interference signal caused by high speed data transmission, which requires a wide transmitting bandwidth and a high transmitting power, in a mixed cell environment where various service signals are co-existed. Also, reliable service must be provided even in Hot spot or shadow area. For overcoming degradation of performance caused by interference signal and channel characteristics, smart antenna technique has been introduced.

An adaptive array antenna system of the present invention is one of smart antennas.

Generally, a transfer function of each transmitting channel must be identical for transmitting signal in specific angle by using the adaptive array antenna. Therefore, an error compensation signal is injected with the transmitted signal to an input port of each channel of conventional array transmitter for obtaining the transfer function of transmitting channel.

The injected signals are transmitted through the array transmitter and the injected signal is received through a feed-back path. By analyzing the injected error compensation signal received through the feed-back path, the transfer function of each transmitting channel of transmitter can be obtained. In here, the transfer function of each channel can be maintained identically by multiplexing an input signal of array transmitter and a reverse of the transfer function of each channel.

As mentioned above, the feed-back path of error compensation signal applied in the adaptive array antenna system can be used for linearizing the array transmitter. Generally, in the linearizing method using a pre-distorter, an output signal of the transmitter is received by feed backing. The received output signal and input signal are compared and non-linear coefficient is estimated in order to minimize difference between the received output signal and input signal. Linearity of transmitter is increased by multiplexing a transmitting signal and estimated non-linear coefficient. As mentioned above, a linearizing apparatus is independently required to each transmitter for applying the linearizing method to a plurality of transmitters in the array antenna system. As a result, a manufacture cost is increased corresponding to the number of array antennas.

Specially, the present invention includes an error compensation apparatus.

The error compensation apparatus compensates a transfer function of each channel of an array transmitter within a baseband processing block by measuring amplitude and a phase of each channel of array transmitter for reducing a side-lobe level generated in non-desired angle in a case of forming desired beam in specific direction by using multichannel transmitter in conventional adaptive array antenna system. The error compensation apparatus includes a feed-back device for feed-backing a transmitting signal to an array antenna, a frequency down converter and A/D converter.

As a conventional method for linearizing a multichannel transmitter in an adaptive array antenna, there is a method only linearizing an amplifier by equipping a linearizing device in the amplifier of each transmitting channel. The linearizing device includes a feed-forward device, a feed-back device and a pre-distorter. The method has an advantage that the transmitter and linear amplifier can be designed independently by only linearizing the amplifier which has most complex non-linearity. However, in the above mentioned method, expensive amplifier must be independently used at each transmitter for implementing the method in the array antenna system having a plurality of transmitters.

As another conventional method for linearizing a multi-channel transmitter in an adaptive array antenna, there is pre-distorting method for feed-backing an output signal of transmitting channel; comparing the output signal with input signal of the transmitting channel; obtaining an non-linear coefficient having minimum difference between output signal and the input signal and multiplexing the non-linear coefficient with digital or analogy input signal. However, the pre-distorting method requires a plurality of linearizing apparatus corresponding to the number of the transmitters. Therefore, a cost of the system is increased corresponding to the number of array antennas.

### SUMMARY OF THE INVENTION

It is, therefore, an object of the present invention to provide an adaptive array antenna system linearizing each transmitting channel by using a feed-back path identical with a feed-back path used for and estimating a transfer function of multichannel transmitter in order to reduce complexity of hardware of linearizing apparatus in adaptive array transmitter and method thereof.

Specially, the present invention sequentially linearizes array transmitters without generating additional feed-back path by using identical feed back path for both compensating error in a transmitting channel and linearizing.

In accordance with an aspect of the present invention, there is also provided an adaptive array antenna system, including: a modulation unit having a plurality of modulators for generating transmitting data corresponding to the number of users; a beamforming unit having a plurality of beamformers for multiplexing the generated transmitting data to a beamforming weight; a vector addition unit for adding outputs of the beam forming unit corresponding to a user; an array error compensation unit for multiplexing a reverse of a transfer function of an array transmitting unit to the transmitting data inputted through the vector addition unit by using a compensation signal inputted through a frequency down conversion unit; an array linearization unit for receiving an output signal from the array error compensation unit, linearizing the received output signal by using the compensating signal from the frequency down conversion unit and transferring the linearized output signal to the array transmitting unit; a compensation signal extraction unit for extracting an output signal of the array transmitting unit and output a compensation signal; a frequency down conversion unit for frequency-down converting the compensation signal extracted from the compensation signal extraction unit; an array transmitting unit for converting the linearized output signal to an analogue signal and frequency-up converting the analogue signal; and an array antenna for transmitting an output signal passed through the compensation signal extraction unit.

In accordance with another aspect of the present invention, there is also provided a linearization method of an adaptive array antenna system, the linearization method including the steps of: a) generating transmitting data corresponding to the number of users; b) generating multiplexed results by multiplexing the generated transmitting data with a beam forming weight; c) adding the multiplexed results from the step b); d) generating error compensated transmitting data by compensating the generated transmitting signal by frequency down converting an output signal of the adaptive array antenna system; and e) linearizing the error compensated transmitting data from the step d) by frequency-down converting the compensation signal and the output signal of the adaptive array antenna system.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram illustrating a conventional adaptive array antenna system having a function of error compensation;

FIG. 2 is a diagram showing a conventional adaptive pre-distortion linearization apparatus;

FIG. 3 is a diagram illustrating an adaptive array antenna system having a function of linearization in accordance with a preferred embodiment of the present invention; and

FIG. 4 is a graph showing an updating period of non-linear coefficient and an updating period of an error compensation coefficient of an adaptive array antenna system having a function of linearization in accordance with a preferred embodiment of the present invention.

### DETAILED DESCRIPTION OF THE PREFERRED EMBODIMENTS

Other objects and aspects of the invention will become apparent from the following description of the embodiments with reference to the accompanying drawings, which is set forth hereinafter.

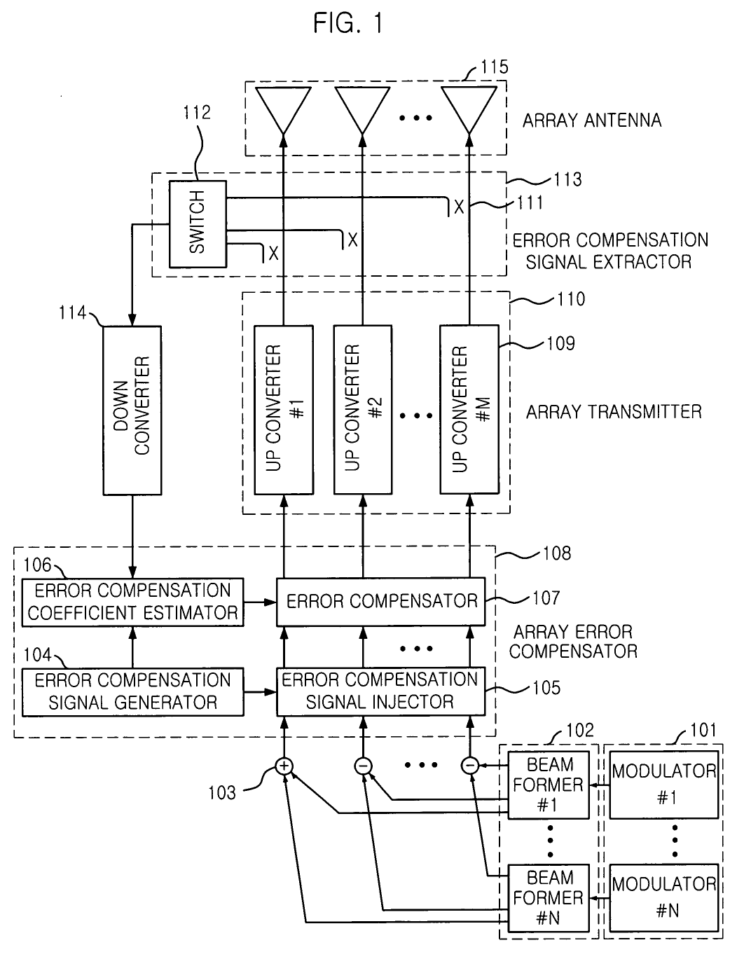

FIG. 1 is a diagram illustrating a conventional adaptive array antenna system having a function of error compensation.

Referring to FIG. 1, the conventional adaptive array antenna system includes a modulator unit 101 having a plurality of modulators for generating transmitting data corresponding to the number of users; a beamforming unit 102 having a plurality of beamformers for multiplexing the generated transmitting data with a beamforming weight and transferring a result of multiplexing to vector adders 103; the vector adders 103 for adding each output of beamformers in beam forming unit 102 corresponding to each user and transferring results of vector adders 103 to an error compensator 108; the error compensator 108 for multiplexing transmitting data with a reverse of transfer function of an array transmitter 110; the array transmitter 110 for converting the transmitting digital data to transmitting analogue data and frequency up-converting the converted analogue data to radio frequency after; an error compensation signal extractor 113 for extracting output signal of the array transmitter 110 and transferring extracted output signal to a down converter 114 in order to compensate a amplitude and phase difference of an array transmitter; and an array antenna 115 for transferring output signal passed through the error compensating signal extractor 113.

The array error compensator 108 includes an error compensating signal generator 104, an error compensation signal injector 105, an error compensation coefficient estimator 106 and an error compensator 107.

In here, the error compensating signal generator 104 generates a digital error compensation signal injected to each transmitter for estimating a transfer function.

Furthermore, the error compensation signal injector 105 generates a digital transmitting data by adding output vector of the vector adder 103 and digital error compensation signal vector.

The error compensating coefficient estimator 106 estimates the transfer function of array transmitter 110 per each channel by considering relation between an error compensation signal passed through the array transmitter 110 and the error compensation signal generated at the error compensation signal generator 104.

The error compensator 107 multiplexes each transmitting channel of the array transmitter 110 and a reverse of the transfer function in order to transfer a transmitting signal generated in baseband having identical characteristics to the array antenna 115.

A digital output signal of the array error compensator 108 is injected to the array transmitter 110. The array transmitter 110 converts digital data of each channel to an analogue signal and includes an up-converter 109 for up-converting the analogue signal to radio frequency and a linearizing apparatus for reducing non-linearity of transmitter.

Specially, a linearizing method used in the linearizing apparatus in the array transmitter 110 includes a method for independently linearizing a power amplifier by using a linear power amplifier and another method for extracting a non-linear coefficient of analogue or digital signal and multiplexing the non-linear coefficient to the input signal by using a pre-distorter.

As mentioned above, the linear apparatus is installed at each up converter 109 and independently performs linearization function at each channel.

An output signal of the array transmitter 110 is extracted from the error compensation signal extractor 113 and the error compensation signal extractor 113 includes a coupler 111 and a switch 112.

The error compensation signal extracted from the error compensation signal extractor 113 is frequency down-converted at a down-convert 114 and the switch 112 sequentially connects an array transmitter 110 and down-converter 114.

The error compensating coefficient estimator 106 analyzes the extracted signal and sequentially estimates transfer functions of array transmitter 110 and estimates error compensation coefficient based on the transfer functions. The error compensation coefficient is inputted to the error compensator 107 and error of amplitude and phase of each transmitting channel is compensated.

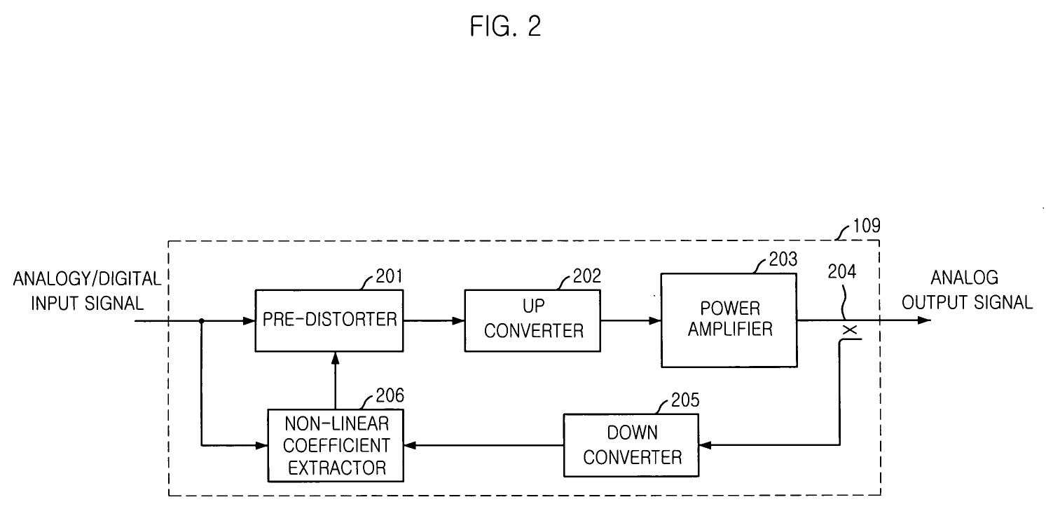

FIG. 2 is a diagram showing a conventional adaptive pre-distortion linearization apparatus.

Referring to FIG. 2, an input signal is non-linearly distorted by being passed through a pre-distorter 201 and an up-converter 202 and the distorted input signal is inputted to an error compensation signal extractor 113. An output signal of a power amplifier 203 having non-linear distortion is extracted by passing through a coupler 204 and frequency down-converted by passing through a down-converter 205, and inputted to a non-linear coefficient extractor 206. The non-linear coefficient extractor 206 compares the extracted output signal and the input signal, extracts a non-linear coefficient and multiplexes the non-linear coefficient to the input signal at the pre-distorter 201.

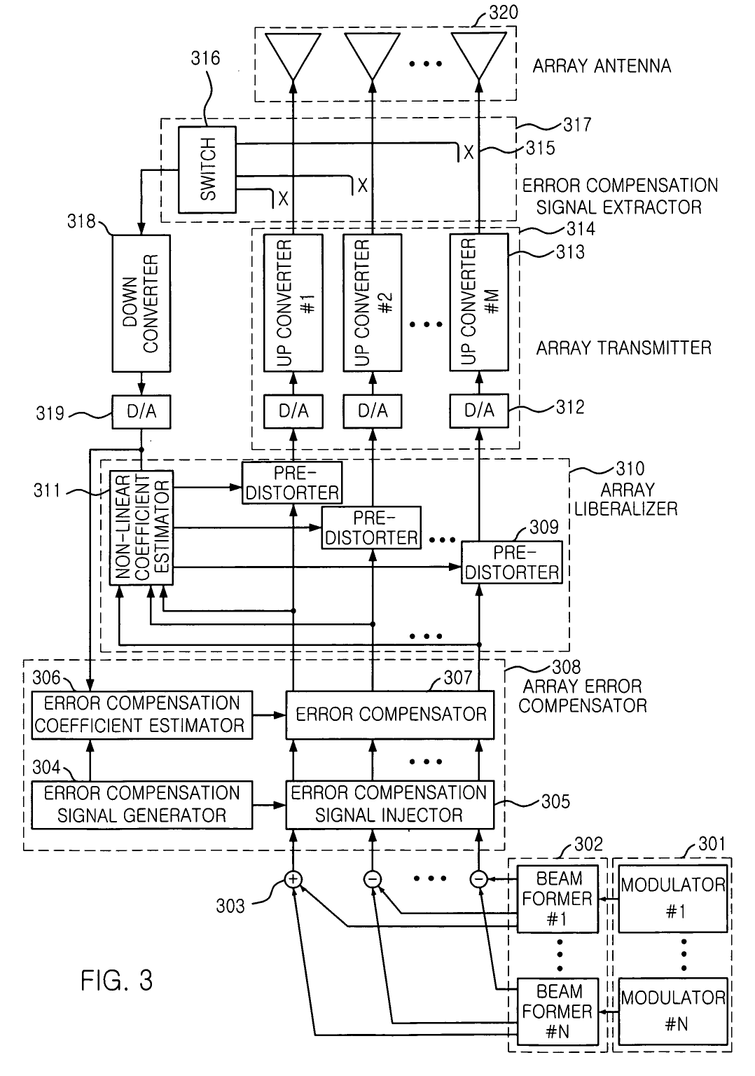

FIG. 3 is a diagram illustrating an adaptive array antenna system having a function of error compensation in accordance with a preferred embodiment of the present invention.

Referring to FIG. 3, the adaptive array antenna system of the present invention further includes an array linearizer 310 comparing to the conventional adaptive array antenna shown in FIG. 1.

In detail, a modulation unit 301 having a plurality of modulators generates transmitting data corresponding to the number of users and a beamforming unit 302 having a plurality of beamformers multiplexes a beamforming weight to the generated transmitting data and transfers a result to vector adders 303.

The vector adders 303 add each output of the beamformers and outputs adding results to an array error compensator 308.

The array error compensator 308 receives outputs of the vector adders 303 and transfers an output of the array error compensator 308 to an array linearizer 310. The array error compensator 308 includes an error compensation signal generator 304, an error compensation signal injector 305, an error compensation coefficient estimator 306 and an error compensator 307.

Inhere, the error compensation signal generator 304 generates a digital error compensation signal to be injected to a channel in order to estimate a transfer function of the array transmitter 314.

The error compensation signal injector 305 generates a digital transmitting data by adding an output vector of the vector adder 303 and a vector of the digital error compensating signal.

The error compensation coefficient estimator 306 estimates the transfer function of the array transmitter 314 per each channel by considering relation between the error compensation signal passed through the array transmitter 314 and the error compensation signal generated at the error compensation signal generator 304.

The error compensator 307 multiplexes each transmitting channel of the array transmitter 314 to a reverse of the transfer function in order to transfer a signal generated at baseband to have identical characteristics until the signal reaches to the array antenna 320.

The array error compensator 308 includes an error compensation signal generator 304, an error compensation signal injector 305, an error compensation coefficient estimator 306 and an error compensator 307.

The error compensation signal generator 304 generates a digital compensation signal to be injected to a channel in order to estimate a transfer function of the array transmitter 314.

The error compensation signal injector 305 generates a digital transmitting data by adding output vector from the vector adder 303 and a vector of the digital error compensation signal.

The error compensation coefficient estimator 306 estimates a transfer function of each channel by analyzing an estimation signal passed through the array transmitter 314. The error compensator 307 multiplexes estimated error compensating coefficient from the error compensating coefficient estimator 306 with each transmitting channel of the array transmitter 314 at each transmitting channel.

An output digital signal estimated at the array error estimator 308 is inputted to the array linearizer 310. In here, the array linearizer 310 includes a non-linear coefficient estimator 311 and a pre-distorter 309. The array linearizer 310 multiplexes a non-linear coefficient of each transmitter channel to an input digital signal.

As mentioned above, the digital output signal of the array linearizer 310 is converted to an analogue signal by a digital/analogue converter 312, passed through an up converter 313 and inputted to a compensation signal extractor 317.

An analogue compensation signal inputted to the compensation signal extractor 317 is extracted at a coupler 315 and sequentially transferred to the down converter 318 at each channel by a switch 316.

The extracted analogue compensation signal from the compensating signal extractor 317 is frequency-down converted by the down converter 318 and converted to digital compensation signal by the analogue/digital A/D converter 319.

The digital compensation signal of the analogue/digital A/D converter 319 is inputted to a non-linear coefficient estimator 311 in the array linearizer 310 in order to compensate non-linearity of the array transmitter 314.

The digital compensation signal inputted to the non coefficient estimator 311 is compared with an input signal of the array transmitter 314 and the non-coefficient is extracted from the digital compensation signal. The non-linear coefficient extracted from the pre-distorter 309 is multiplexed with the input signal of the array transmitter 310.

A transfer function of each channel of the array transmitter 314 is estimated by considering relation between the inputted signal of the error compensation coefficient estimator 306 and the error compensation signal generated at the error compensation signal generator 314. Furthermore, the inputted signal is multiplexed with the estimated transfer function in order to transfer the inputted signal to have identical characteristics until it reaches to the array antenna.

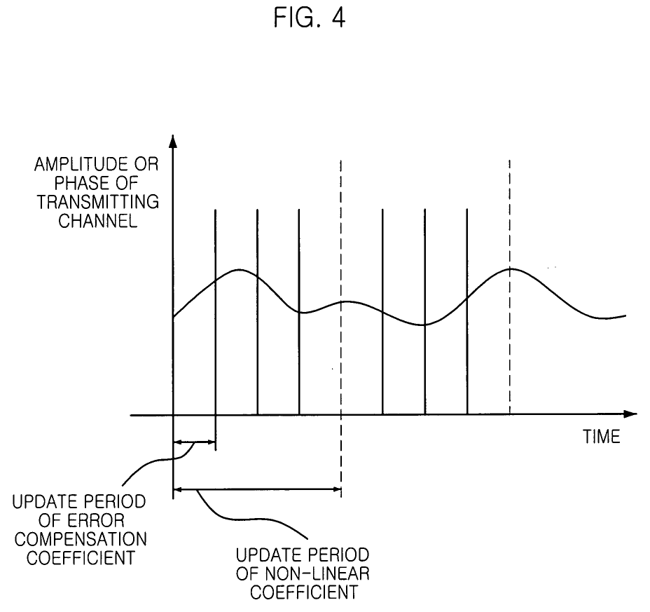

FIG. 4 is a graph showing an updating period of non-linear coefficient and an updating period of error compensation coefficient in an adaptive array antenna system having a function of linearization in accordance with a preferred embodiment of the present invention.

In detail, FIG. 4 shows that a relation between the updating time of the non-linearity coefficient when linearizing the array transmitter 314 by multiplexing an estimated non-linearity coefficient at the non-linear coefficient estimator 311 and the updating time of the error compensating coefficient when compensating an amplitude and phase difference of the array transmitter 314 by multiplexing an estimated error compensation coefficient from the error compensation coefficient estimator 306 at the error compensator 307.

Inhere, there is an assumption that the transfer function of each transmitting channel is not varied when an error is compensated at the array transmitter 314.

As mentioned above, the array linearizer 310 of the present invention multiplexes the extracted non-linear coefficient to an input signal of the pre-distorter 309 and it is transferred to each transmitting channel for compensating non-linearity of the array transmitter 314. As a result, the transfer function of each transmitting channel is varied. Therefore, in the present invention, the updating period of the error compensation coefficient of the array error compensator 308 sets to be faster than the updating period of the non-linear coefficient by the array linearizer 310. By providing faster updating period of the error compensation coefficient, the transfer function of the array transmitter 314 can be obtained within a variation period of transfer function of each transmitting channel by the pre-distorter 309.

The above mentioned present invention can be implemented as computer executable instructions and can be stored in a computer readable recoding medium such as a CD-ROM, RAM, ROM, floppy disk, hard disk and optical magnetic disk.

As mentioned above, the adaptive array antenna system having a function of linearizing in accordance with the present invention can increase linearity of transmitting channel by using an error compensator without adding additional feedback device. That is, each transmitting channel of array transmitter can be sequentially linearized by adding a linearizer apparatus in digital or analogue region without modifying conventional adaptive array antenna transmitting system.

Moreover, the present invention is not necessary to install the linearization apparatus corresponding to the number of array antenna. Therefore, a manufacture cost can be decreased.

While the present invention has been described with respect to certain preferred embodiments, it will be apparent to those skilled in the art that various changes and modifications may be made without departing from the scope of the invention as defined in the following claims.

1. An adaptive array antenna system, comprising:
modulation means having a plurality of modulators for generating transmitting data corresponding to the number of users;
beam forming means having a plurality of beam formers for generating a multiplexed data by multiplexing the generated transmitting data to a beam forming weight;
vector addition means for generating sum data by adding outputs of the beam forming means corresponding to a user;
array error compensation means for generating error compensated data by multiplexing a reverse of a transfer function of an array transmitting means to the sum data from the vector addition means by using a compensation signal inputted through a frequency down conversion means;
array linearization means for receiving the error compensated data from the array error compensation means, generating linearized signal by linearizing the error compensated data by using the compensating signal from the frequency down conversion means and transferring the linearized signal to the array transmitting means;
compensation signal extraction means for extracting a compensation signal from an output signal of the array transmitting means and outputting the compensation signal;
frequency down conversion means for generating a converted signal by frequency-down converting the compensation signal;
array transmitting means for converting the linearized signal from the 0array linearization means to an analogue linearized signal and frequency-up converting the analogue linearized signal; and
array antenna for transmitting an output signal passed through the compensation signal extraction means.

2. The adaptive array antenna system as recited in claim 1, the array error compensation means includes:
error compensation signal generation means for generating a digital error compensation signal to be injected to a channel in order to estimate the transfer function of the array transmitting means;
error compensation signal injection means for generating digital transmitting data by adding an output vector of the vector addition means and a vector of the digital error compensation signal vector;
error compensation coefficient estimation means for estimating an error compensation coefficient of each channel by considering relation between the compensation signal from the frequency down conversion means and the error compensation signal generated from the error compensation signal generation means; and
error compensation means for multiplexing a reverse of the error compensation coefficient to the digital transmitting data generated from the error compensation signal injection means in each transmitting channel of the array transmitting means and transferring a result of the multiplexing to the array linearization means.

3. The adaptive array antenna system as recited in claim 1, wherein the array linearization means includes:
non-linear coefficient extraction means for receiving an output signal of the array error compensation means, comparing the output signal and the compensating signal from the frequency down conversion means and extracting the non-linear coefficient; and
pre-distortion means for linearizing the error compensated signal from the array error compensation means by multiplexing the extracted non-linear coefficient to the array error compensated signal.

4. The adaptive array antenna system as recited in claim 3, wherein the error compensation coefficient is the transfer function of the array transmitting means.

5. The adaptive array antenna system as recited in claim 3, wherein an updating period of error compensation coefficient is faster than an updating period of the non-linear coefficient.

6. A linearization method of an adaptive array antenna system, the linearization method comprising the steps of:
a) generating transmitting data corresponding to the number of users;
b) generating multiplexed data by multiplexing the transmitting data with a beam forming weight;
c) generating sum data by adding the multiplexed data;
d) generating error compensated data by compensating the transmitting signal by frequency down converting an output signal of the adaptive array antenna system; and
e) linearizing the error compensated data from the step d) by frequency-down converting the compensation signal and the output signal of the adaptive array antenna system.

7. The method as recited in claim 6, wherein the step d) includes the steps of:
d-1) generating a digital error compensation signal to be injected to a channel in order to estimates a transfer function of an array transmitting means in the adaptive array antenna system;
d-2) generating digital transmitting data by adding the sum data from step c) and the digital error compensation signal from the step d-1);
d-3) estimating an error compensation coefficient by considering a relation between the frequency down converted compensation signal and the digital error compensation signal; and
d-4) multiplexing the digital transmitting signal form the step d-2) and a reverse of the error compensation coefficient from the step d-3).

8. The method as recited in claim 6, wherein the step d-2) includes:
d-2-I) receiving the error compensated signal from the step d), comparing the error compensated signal and the frequency down compensated signal and extracting the non-linear coefficient; and
d-2-II) linearizing the error compensated signal from the step d) by multiplexing the extracted non-linear coefficient.

9. The method as recited in claim 8, wherein an updating period of error compensation coefficient is faster than an updating period of the non-linear coefficient.

10. The method as recited in claim 8, wherein the error compensation coefficient is the transfer function of the array transmitting means.
